(19) United States
(12) Patent Application Publication
(10) Pub. No.: US 2025/0130925 A1
(43) Pub. Date: Apr. 24, 2025

(54) PROVIDING AUTOMATED APPLICATION FEEDBACK FOR SOFTWARE TESTING

(71) Applicant: DELL PRODUCTS L.P., Round Rock, TX (US)

(72) Inventor: Shiva Prasad H N, Udupi (IN)

(21) Appl. No.: 18/489,453

(22) Filed: Oct. 18, 2023

(51) Int. Cl. G06F 11/36

(52) U.S. Cl. CPC G06F 11/368; G06F 11/3688

(57) ABSTRACT

An information handling system collects telemetry data associated with an application, and processes the telemetry data of the application to derive a pattern. The system analyzes the telemetry data to identify test data and a test scenario based on the pattern, and generates a test case based on the test data and the test scenario.

### FIELD OF THE DISCLOSURE

The present disclosure generally relates to information handling systems, and more particularly relates to providing automated application feedback for software testing.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system collects telemetry data associated with an application, and processes the telemetry data of the application to derive a pattern. The system analyzes the telemetry data to identify test data and a test scenario based on the pattern, and generates a test case based on the test data and the test scenario.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIGS. 2 and 3 are block diagrams of an environment for providing automated application feedback, according to an embodiment of the present disclosure;

FIG. 4 is a flowchart of a method for providing automated application feedback, according to an embodiment of the present disclosure;

FIG. 5 is a flowchart of a method for generating one or more test cases, according to an embodiment of the present disclosure;

FIG. 6 is a table of application data, according to an embodiment of the present disclosure; and

FIGS. 7, 8, and 9 are tables of analyzed data, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

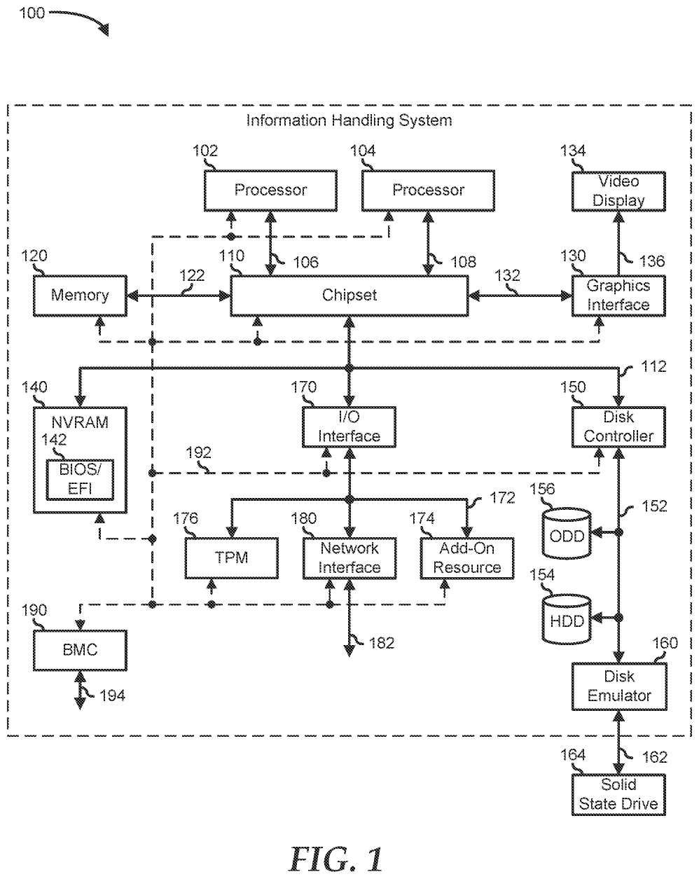

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include a I²C bus, a System Management Bus (SMBus), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I²C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

It is typically challenging for software test teams to collect and analyze data manually on aspects of customer usage of an application. In addition to being tedious and inefficient, manual analysis may not be reliable due to inconsistent and incomplete information. Information from multiple sources frequently is unstructured. In addition, writing and maintaining test cases are resource intensive. To address these and other concerns, the present disclosure provides a system and method for automatically analyzing data collected from one or more applications and generating test cases accordingly.

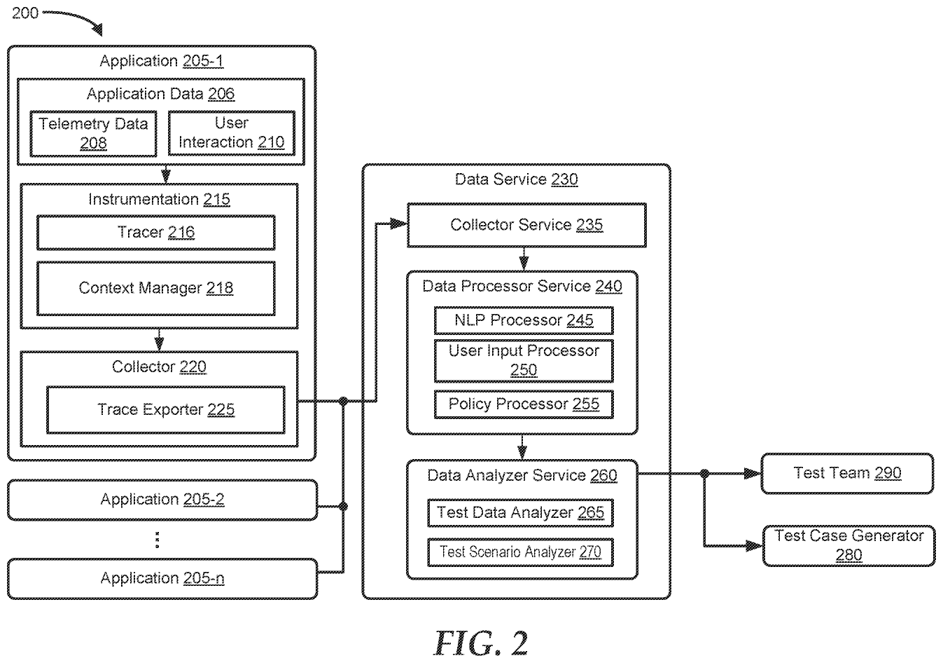

FIG. 2 shows an environment for providing automated application feedback. Environment 200 includes applications 205-1 through 205-n, data service 230, a test team 290, and a test case generator 280. Each of applications 205-1 through 205-n may be different or the same software applications. However, each of applications 205-1 through 205-n may have similar components to application 205-1. Application 205 includes an application data 206, an instrumentation 215, and a collector 220. Application data 206 includes a telemetry data 208 and a user interaction data 210. Instrumentation 215 includes tracer 216 and a context manager 218. Collector 220 includes a trace exporter 225. The components of environment 200 may be implemented in hardware, software, firmware, or any combination thereof. The components shown are not drawn to scale and environment 200 may include additional or fewer components. In addition, connections between components may be omitted for descriptive clarity. Further, although test case generator 280 is shown as separate from data service 230, test case generator 280 may be included as one of the services in data service 230.

Application 205 may be a customer software application that is under testing which includes capturing user interaction data 210 to determine usage patterns. For example, application 205 may be a software component of a management controller, such as iDRAC. User interaction data 210 may include interactions of a user with application 205 using various means such as via input devices that include a keyboard, a mouse, a touchscreen, a controller, or similar. Examples of user interaction include a mouse click, menu selection, gesture, voice command, etc. Telemetry data 208 may include metrics, logs, and traces associated with application 205.

Instrumentation 215 may be used to instrument or generate traces, logs, or metrics associated with application 205. For example, the instrumentation can yield user interaction information, such as an application context, user interface actions, time spent by a user at a specific application state, application session details, etc. The instrumentation may be performed by implementing a trace-type data source for each application user interaction. For example, instrumentation 215 may be implemented with span specification in OpenTelemetry®, wherein each span represents an application user interaction per session. In one example, instrumentation 215 or tracer 215 may add application user interaction data as OpenTelemetry® span or structure which may be sent to data service 230. Each span may represent one user interaction per session. Each application user interaction may include one or more elements, such as an identifier, a timestamp, an attribute, a status, a link to another application user interaction, etc. Instrumentation 215 may be configured to generate and output trace data, logs, and/or metrics for collection by collector 220. The trace data may also include metric instrumentation to provide time-series based user interaction data and derive software performance test feedback. Trace exporter 225 may be configured to transmit the collected output trace data to data service 230. In one embodiment, trace exporter 225 may be implemented using OpenTelemetry® logging exporter.

Tracer 216 may be used for deriving or creating application user interactions and interactions with other application user interactions within a context mechanism. For example, tracer 216 may create an application user interaction associated with a user interaction and nested application user interactions. The nested application user interactions associated with user interactions may be created to capture application elements, user inputs, and user actions. The application user interactions may be implemented to include links as relationships between the application elements. For example, the application user interactions may include an application user interaction identifier, a parent identifier, and a trace identifier that links the application user interaction to the trace it originated from. Tracer 216 may use the links to generate nested application user interactions.

In addition, tracer 216 may add semantic attributes to provide additional details for the application user interactions. For example, application user interaction failures may be captured using the status element and an exception associated with the failure can be recorded as an event. Context manager 218 may be configured to use a text-based approach to provide context to remote services. This approach may be implemented with a World Wide Web Consortium (W3C®) trace context and built by nesting the application user interactions.

Data service 230 may be configured to collect, process, and analyze data received from trace exporter 225. The data can be used to generate feedback on a test scenario and/or test data, which may be transmitted to a test team 290 and/or test case generator 280, wherein the feedback may be based on the derived information and patterns. The feedback may be used by test case generator 280 to generate one or more test cases. Collector service 235 may be used to collect application data from application 205 and transmit the collected application data to data processor service 240.

Data processor service 240 may be configured to process the application data received from collector service 235 for analysis by data analyzer service 260. Processing the application data includes applying NLP techniques by NLP processor 245 to derive noun and/or verb phrases from the application data. The data processing also includes applying regular expression patterns by user input processor 250. This is performed to extract additional context information, such as an internet protocol address, a user input type, a version, etc. Additional rule-based policies may be used by policy processor 255 to extract known data context, such as an operation protocol. For example, policy processor 255 may extract product names, feature names, etc. This allows flexibility in generating the test cases by allowing an ability to add a feature in the policies whenever the new feature is to be tested.

Data analyzer service 260 may be used to consume the processed application data to perform conjoint data analysis and generate feedback. Test scenario analyzer 270 may be configured to generate feedback that includes a scenario likelihood, a use case scenario distribution, a positive versus negative scenario distribution, and a repeatability limit. Test data analyzer 265 may be configured to generate feedback that includes data boundaries and data partitions for string-type data. For non-string type data, the feedback may include unique versus repeatable test data and test configuration requirement prioritization. The feedback may be transmitted to test team 290 and/or test case generator 280. The feedback may be used by test team 290 to derive test configuration and scenario prioritization. In addition, the feedback may be used by test case generator 280 to generate test cases which may be used to standardize the test data prioritization ranking. The generated test cases can be used to test other applications.

Test case generator 280 may be configured to process feedback from data analyzer service 260 to generate independent test cases. For example, test case generator 280 may process feedback from analyzed user interaction data 210 to generate independent test cases. Test case generator 280 may follow a format: For a given <test data>, verify <success/failure> of <test scenario objective> <test scenario repeatability limits> times. Each step in the test case can be based on test scenario actions.

Those of ordinary skill in the art will appreciate that the configuration, hardware, and/or software components of environment 200 depicted in FIG. 2 may vary. For example, the illustrative components within environment 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description. In addition, those of ordinary skill in the art may appreciate that applications 205 may be located locally or remotely from each other and data service 230. For example, one of applications 205 may be in various geographic locations. In particular, data service 230 may be provided as a cloud service accessible by applications 205 via a network.

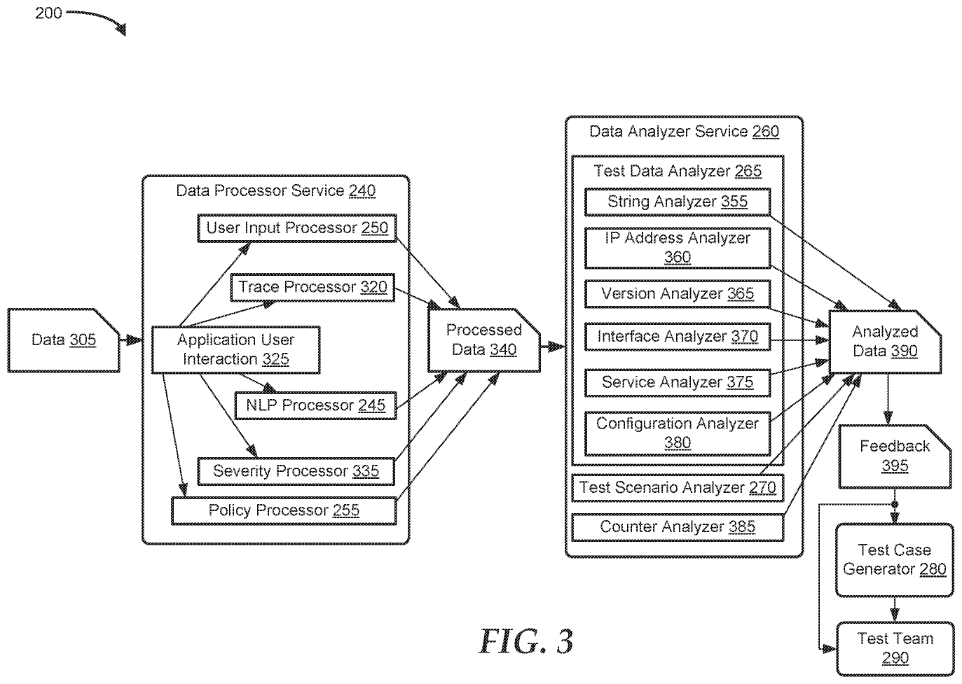

FIG. 3 shows environment 200 in greater detail. Data 305 may include telemetry data 208 and user interaction data 210 collected by collector 220 and transmitted by trace exporter 225. In addition, data 305 may include trace, log data, and/or other metrics generated by instrumentation 215. Collector service 235 may extract application user interaction 325 from data 305 and transmit the extracted application user interaction 325 to data processor service 240 for processing. In particular data processor 240 may process application user interaction 325 for information, understand operation context, and derive patterns. In addition, data processor service 240 may consolidate the processed data prior to providing the processed data to data analyzer service 260. Data 305 may also be data collected from various applications. In another embodiment, collector service 235 may collect data 305 from one or more applications. Data 305 includes application user interaction 325 that were created and/or derived by instrumentation 215.

User input processor 250 may be configured to use regular expression patterns to identify various information including test data identifiers, values, and user input types, such as a plain string, text, an internet protocol address, an application version, a counter, an interface, a job, a service, an application component, etc. The identified information may be transmitted as part of processed data 340 to data analyzer service 260.

Trace processor 320 may be configured to use a plain algorithm to generalize trace messages included in application data 206. For example, trace processor 320 may separate a trace message static word from user inputs. Trace processor 320 may then transmit the generalized trace messages as part of processed data 340 to data analyzer service 260. NLP processor 245 may be configured to use NLP techniques to identify trace parts of speech tags and extract noun and verb phrases from telemetry data. Words identified as nouns may be identified as test objectives while verb phrases as test actions by data analyzer service 260. NLP processor 245 may transmit the extracted noun and verb phrases as part of processed data 340 to data analyzer service 260. Severity processor 335 may be configured with a mapping algorithm to convert user interaction failures into severity objects. Severity objects may be classified as one of two test scenario types, such as a positive test scenario or a negative test scenario by data analyzer service 260.

Data analyzer service 260 may analyze the processed data for test data and test scenarios. The analysis performed may be specific to an application user interaction. The analysis may generate analyzed data 390 which may then be formatted to create feedback 395 which includes test data boundaries, test data partitions, test data value occurrence, test data value distributions, test scenario types, test scenario objectives, test scenario actions, test scenario repeatability limits, etc. Feedback 395 may be transmitted to test team 290 and test case generator 280.

Test data analyzer 265 may be configured to analyze processed test data to generate feedback 395. Test data analyzer 265 includes a string analyzer 355, an internet protocol address analyzer 360, a version analyzer 365, an interface analyzer 370, a service analyzer 375, and a configuration analyzer 380. String analyzer 355 may be configured to derive test data boundaries, such as maximum length of string characters used, minimum length of string characters used, and average length of string characters used. String analyzer 355 may also be used to determine test data partitions, such as a set of characters used that includes digits, alphabets, cases, and special characters. The test data boundaries and the test data partitions may be included in analyzed data 390.

Internet protocol address analyzer 360 may be configured to determine an internet protocol class priority, such as a maximum occurrence of an internet protocol class. Internet protocol address analyzer 360 may also be used to determine internet protocol configuration priority, such as private internet protocol versus public internet protocol distribution. Internet protocol address analyzer 360 may include the maximum occurrence of an internet protocol class and the internet protocol configuration priority as part of analyzed data 390.

Version analyzer 365 may be configured to determine version test prioritization based on a version of the application and its components. Because there is a plurality of possible versions in the field, identifying the actual version of the application and its components allows test case generator 280 to prioritize testing using the identified versions. Interface analyzer 370 may be configured to determine interface test distribution. For example, interface analyzer 370 may derive the distribution among a list of architecture protocols, such as secure shell protocol, Redfish® interface, IPMI, hypertext transfer protocol (HTTP), HTTP Secure, WSMan, etc.

Service analyzer 375 may be configured to determine service test distribution. For example, service analyzer 375 may derive the distribution among a list of application interfaces that can be used by a customer, wherein the list may include a login service, deployment service, account service, metric service, etc. Different application types may include different application interfaces that may be exposed to the customer. Configuration analyzer 380 may be used to determine configuration test distribution. The different distributions and version test prioritization may be included as part of analyzed data 390. For example, configuration analyzer 380 may derive the distribution among a list of application environments that includes a virtualization platform, an operating system, an application deployment model, etc.

Counter analyzer 385 may be configured to provide repeatability limits for an application user interaction. The repeatability limit may indicate how many times the test case is repeated based on information regarding customer usage. For example, if the feedback indicates that the customer logged in n-number of times, then the repeatability limit may be n or n+1. Test scenario analyzer 270 may be configured to determine test objectives from noun phrases and test actions from verb phrases in application data 206. Test scenario analyzer 270 may also be configured to determine a test scenario type, such as one of a positive test, a negative test, or a destructive test based on the status of the user interaction object. Analyzed data 390 may be formatted as feedback 395 for consumption of test case generator 280. Test case generator 280 may use feedback 395 to generate one or more test cases, which may be transmitted to test team 290 and/or added to a testing framework. Feedback 395 may also be transmitted to test team 290.

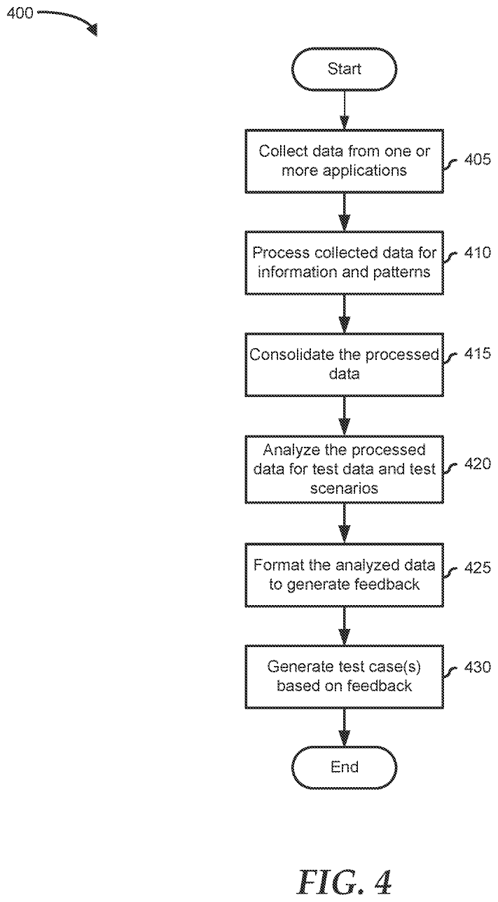

FIG. 4 shows flowchart of a method 400 for providing automated application feedback. Method 400 may be performed by one or more components of environment 200 of FIGS. 2 and 3. For example, one or more blocks may be performed by data service 230 and test case generator 280. However, embodiments of the present disclosure are described in terms of environment 200 of FIGS. 2 and 3, it should be recognized that other environments may be utilized to perform the described method. One of skill in the art will appreciate that this flowchart explains a typical example, which can be extended to advanced applications or services in practice.

Method 400 typically starts at block 405 where the collector service may collect data from one or more applications. Data collected includes telemetry data, user interaction data, and/or similar. Telemetry data includes metrics, logs, and traces associated with the application. For example, telemetry data may include user interaction traces. The method may proceed to block 410.

At block 410, the data processor service may process the collected data for known information and patterns. Processing of the data includes applying NLP techniques to derive nouns and verb phrases. The processing also includes applying regular expression patterns to extract context information such as internet protocol address, user input type, software version, etc. In addition, the data processor service may apply rule-based policies to extract data context, such as operation protocols. The method may proceed to block 415, where the data processor service may consolidate the processed data prior to transmitting the consolidated data to the data analyzer service. The method may proceed to block 420.

At block 420, the data analyzer service may analyze the processed data to generate test data and test scenario prioritization. The method may proceed to block 425 where the data analyzer service may format the analyzed data to generate feedback from the test scenario and test data. The feedback may be transmitted to the test team and/or the test case generator. The test team may use the feedback to prioritize test scenarios and/or derive test configurations. The method may proceed to block 430 where the test cage generator may generate test cases based on the feedback received. In another embodiment, the analyzed data may be transmitted to the test case generator unformatted which may then be used by the test case generator to generate one or more test cases.

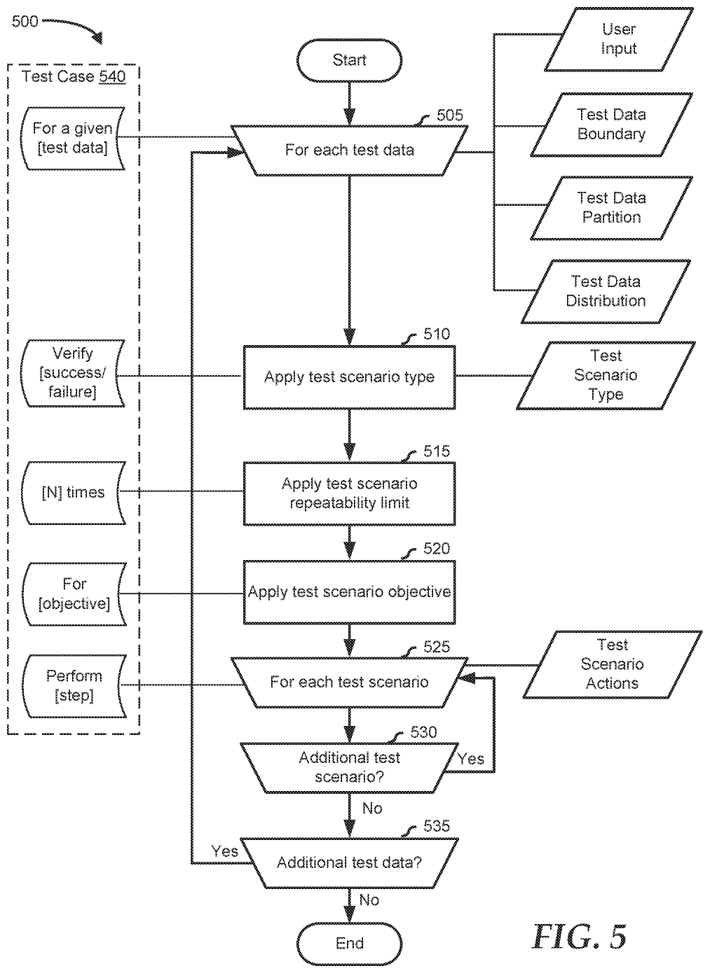

FIG. 5 shows a flowchart of a method 500 for automatically generating one or more test cases based on the feedback or analyzed data received from the data analyzer service. Method 500 may show details associated with block 430 of FIG. 4 and performed by one or more components of environment 200 of FIGS. 2 and 3. For example, one or more blocks of method 500 may be performed by test case generator 280 of FIGS. 2 and 3. However, embodiments of the present disclosure are described in terms of environment 200 of FIGS. 2 and 3, it should be recognized that other environments may be utilized to perform the described method. One of skill in the art will appreciate that this flowchart explains a typical example, which can be extended to advanced applications or services in practice.

Method 500 typically starts at block 505 where the test case generator may generate a test case 540 for each test data that includes a user input, a test data boundary, a test data partition, and a test data distribution. The method may proceed to block 510 where the test case generator may include a success or failure verification of a test scenario objective to be added to the test case at 510. The method may proceed to block 515 where the test case generator may include a repeatability limit to the test case, wherein the test case is applied for a test scenario objective at 520. Each step in the test case may be generated based on test scenario actions at block 525. The test case generator may determine if there is an additional test scenario for processing at block 530. If there is a test scenario to be added as a step in the test case, then the “YES” branch is taken, and the test case generator may add that test scenario as an additional step. If there is no more test scenario left to be added for that test case, then the “NO” branch is taken, and the method may proceed to block 535. At block 535, the test case generator may determine if there is additional test data to be processed. If there is another test data, then the “YES” branch is taken, and the method proceeds to block 505. If there is no more test data to be processed, then the “NO” branch is taken, and the method ends.

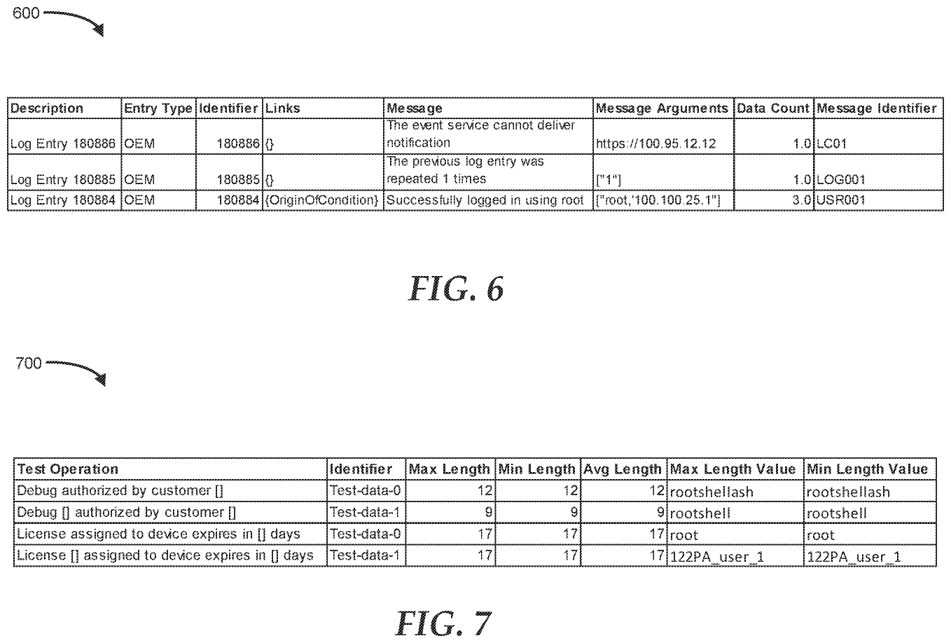

FIG. 6 shows a table 600 of log data associated with an application. The log data include keys “Message Arguments,” to indicate inputs and “Message” to indicate an operation that was performed. The log data may also include a key “Severity” that can indicate whether the operation is positive or negative. Other application data, such as telemetry data and user interaction data, can be processed and analyzed.

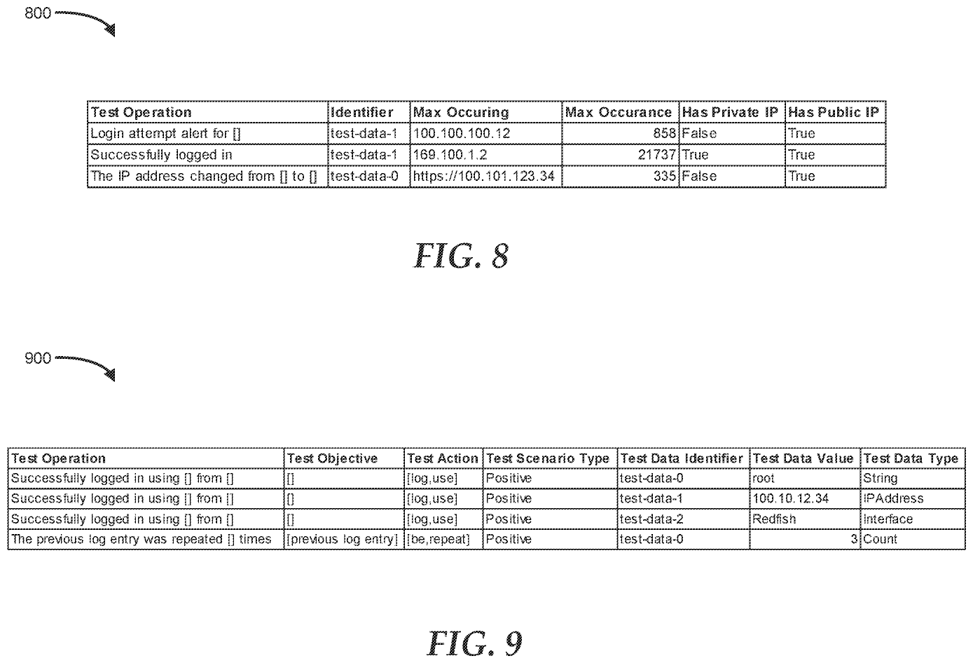

FIGS. 7, 8, and 9 show tables 700, 800, and 900 of analyzed data. The analyzed data shown is not necessarily based on table 600 of FIG. 6. Table 700 shows an example of feedback as an output after a test data analysis. In this example, the analysis may have determined account names used in the application user interactions. Table 800 shows an example of analyzed data based on an analysis related to internet protocol addresses that are associated with a application user interaction. In this example, table 800 includes information regarding a number of successful logins, unsuccessful logins, etc. associated with a particular internet protocol address. Table 900 shows an example of analyzed data based on a test scenario analysis that shows features associated with an application user interaction. For example, table 900 shows an action, a scenario type, data value, etc. associated with the application user interaction. One of skill in the art will appreciate that the application data and analysis shown in these tables are examples, and that application data and analysis performed may vary.

As used herein, a hyphenated form of a reference numeral refers to a specific instance of an element and the un-hyphenated form of the reference numeral refers to the collective or generic element. Thus, for example, application “205-1” refers to an instance of an application class, which may be referred to collectively as applications “205” and any one of which may be referred to generically as an application “205.”

Although FIGS. 4 and 5 show example blocks of method 400 and method 500 in some implementations, method 400 and method 500 may include additional blocks, fewer blocks, different blocks, or differently arranged blocks than those depicted in FIGS. 4 and 5. Those skilled in the art will understand that the principles presented herein may be implemented in any suitably arranged processing system. Additionally, or alternatively, two or more of the blocks of method 400 and method 500 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
collecting, by a processor, user interaction data associated with an application;
processing the user interaction data of the application to derive a pattern;
subsequent to the processing, analyzing the user interaction data to identify test data and a test scenario based on the pattern; and
generating a test case based on the test data and the test scenario.

2. The method of claim 1, further comprising generating trace data.

3. The method of claim 1, further comprising generating an application user interaction based on the user interaction data.

4. The method of claim 3, wherein the application user interaction includes a user input.

5. The method of claim 3, further comprising linking the application user interaction to another application user interaction.

6. The method of claim 1, wherein the test case may include at least one step based on the test scenario.

7. The method of claim 3, further comprising determining a repeatability limit for the application user interaction.

8. The method of claim 7, further comprising extracting a noun and a verb phrase from the user interaction data.

9. An information handling system, comprising:
a processor; and
a memory storing instructions that when executed cause the processor to perform operations including:
collecting telemetry data associated with an application;
processing the telemetry data of the application to derive a pattern;
subsequent to the processing, analyzing the telemetry data to identify test data and a test scenario based on the pattern; and
generating a test case based on the test data and the test scenario.

10. The information handling system of claim 9, wherein the operations further comprise generating trace data.

11. The information handling system of claim 9, wherein the operations further comprise generating a application user interaction based on the telemetry data.

12. The information handling system of claim 11, wherein the operations further comprise linking the application user interaction to another application user interaction.

13. The information handling system of claim 9, wherein the test case may include at least one step based on the test scenario.

14. A non-transitory computer-readable medium to store instructions that are executable to perform operations comprising:
collecting user interaction data associated with an application;
processing the user interaction data of the application to derive a pattern;
subsequent to the processing, analyzing the user interaction data to identify test data and a test scenario based on the pattern; and
generating a test case based on the test data and the test scenario.

15. The non-transitory computer-readable medium of claim 14, wherein the operations further comprise generating trace data.

16. The non-transitory computer-readable medium of claim 14, wherein the test case may include at least one step based on the test scenario.

17. The non-transitory computer-readable medium of claim 14, wherein the operations further comprise generating a application user interaction based on the user interaction data.

18. The non-transitory computer-readable medium of claim 17, wherein the application user interaction includes a user input.

19. The non-transitory computer-readable medium of claim 17, wherein the application user interaction further comprise extracting noun and verb phrases from the user interaction data.

20. The non-transitory computer-readable medium of claim 17, wherein the operations further comprise linking the application user interaction to another application user interaction.
